(19) United States
(12) Patent Application Publication
(10) Pub. No.: US 2011/0058554 A1
(43) Pub. Date: Mar. 10, 2011

(54) METHOD AND SYSTEM FOR IMPROVING THE QUALITY OF REAL-TIME DATA STREAMING

(76) Inventors: Praval Jain, New Delhi (IN); Prashant Aggarwal, New Delhi (IN)

(21) Appl. No.: 12/616,784

(22) Filed: Nov. 12, 2009

(30) Foreign Application Priority Data
Sep. 8, 2009 (IN) 1852/DEL/2009

(51) Int. Cl. H04L 12/56

(52) U.S. Cl. 370/392

(57) ABSTRACT

A method for improving quality of real time data streaming over a network. The network includes a plurality of nodes. A source node in the plurality of nodes transmits a real time data packet to a destination node in the plurality of nodes. First, the source node obtains maximum latency information about the data packet of a data frame. The source node stores information about the maximum latency in the data packet. Then, the source node and zero or more intermediate nodes route the data packet from the source to the destination such that the data packet reaches the destination before the maximum latency expires. Each intermediate node, updates the maximum latency of a packet by subtracting the time spent by the packet at the intermediate node from the maximum latency value received along with the packet.

### FIELD OF THE DISCLOSURE

The present disclosure relates generally to data transfer over a network and more particularly to methods and systems for improving the quality of streaming real time data over a network.

### BACKGROUND

Streaming has become an increasingly popular way to deliver content on the Internet. Streaming allows clients to access data even before an entire file is received from a server, thereby eliminating the need to download multimedia files such as, graphics, audio or video files. A streaming server streams data to the client, while the client processes the data in real time. Various websites have emerged for streaming a variety of content; for example, Youtube and Vimeo (for video), Houndbite and Odeo (for audio), Scribd, Docstoc and Issuu (for documents), OnLive and Miniclip (for games).

For smooth streaming, a minimum network bandwidth is required; for example, a video created at 128 Kbps, will require a minimum bandwidth of 128 Kbps for smooth streaming. If the bandwidth is more than this minimum, the client receives data faster than required, enabling the client to buffer the excess data. However, problems arise if the available bandwidth is lower than the minimum required, as the client has to wait for the data to arrive.

Recently, there has been a shift towards streaming real-time content; for example, a live sports event. Real-time content streaming differs from non-real time content streaming simply because the user cannot wait for real time content to buffer if the available bandwidth is lower than the required bandwidth, as was the case with non-real time data. These problems have often been mitigated by reserving network resources before streaming. In one method, a source node (for example, streaming server) requests required bandwidth from all the nodes in the path up to the destination node (client) in the network. The source initiates data transfer only when it receives a confirmation from all the nodes in the path that they have reserved the requested bandwidth. Such resource reservation based schemes give better performance, as resources are pre-reserved. If the reserved nodes are requested for additional bandwidth by some other node then these nodes may reject the request, if sufficient bandwidth is not available. However, these schemes may be quite wasteful as reserved resources may not be fully utilized by the nodes, and other nodes may be deprived.

Some other techniques use prioritization to solve the problems in streaming real-time video. Different levels of priority are assigned to data (such as highest priority to real time data, next highest to video/audio, lowest to non-multimedia downloads, and so on) and the nodes process the data based on the assigned priority levels. Priority based schemes utilize nodes more efficiently as these schemes treat data from different nodes in the same manner as long as the data is assigned the same priority. Due to this, however, latency performance is lower as compared to the performance of reservation-based schemes.

Another conventional technique controls the amount of “in-transit” data between a transmitter and receiver. In this technique, a data block is sent from the transmitter to the receiver. The time taken to receive the data is measured, and used to calculate the corresponding connection rate. This rate is then sent to the transmitter, which sends a small amount of data to the receiver. Again, the time taken for the transfer is measured and the corresponding throughput is calculated. If this throughput is lower than the transfer rate calculated earlier, the size of data being sent is increased; else, the size of data is decreased. By controlling the amount of data transfer, latency can be controlled. However, the basic problem with this approach is that the network, instead of the application, decides the throughput. In real time applications, allowing the network to curb the required throughput leads to a number of problems.

Yet another scheme is called intelligent packet dropping. As data rates supported by a network vary a lot, especially, in wireless networks, the initial measured data rate may not be available at all times. At times when sufficient data rate in not available, packet queues in some of the nodes tend to fill up. The type of data (real time, non-real time, etc.) being carried by a data packet is typically indicated in a packet header. This information is used to intelligently drop packets, so that all dependant data packets are discarded first. Whenever a packet is dropped, all corresponding dependant packets are also dropped. However, this technique suffers from several drawbacks. Independent data packets remain in queues even when their scheduled times have expired, which unnecessarily creates bottlenecks in node queues, decreasing the network performance.

Accordingly, there exists a need for a method and system for streaming real time data over a network that addresses at least some of the shortcomings of past and present communication techniques.

### SUMMARY

The present disclosure is directed to a method and system for improving the quality of real time data streaming over a network comprising multiple nodes, including a source node, a destination node, and zero or more intermediate nodes. The source node transmits a real time data packet to the destination node. Intermediate nodes route the real time data packet such that it reaches the destination node before a maximum latency expires.

One aspect of the present disclosure improves the quality of real time data streaming over a network by dropping a real time data packet at the source node or at the intermediate nodes when the time taken to reach the destination node exceeds the maximum latency of the real time data packet.

Another aspect of the present disclosure improves the quality of real time data streaming over a network by dropping remaining packets of a data frame in a current node and in one or more neighboring nodes, in response to dropping a packet of the data frame at a current node.

Yet another aspect of the present disclosure improves quality of real time data streaming over a network by dropping a real time data packet of a lower priority data frame at a current node and at one or more neighboring nodes, in response to dropping the real time data packet of the higher priority data frame at the current node. Priorities are assigned to data frames and the priority of each data frame is further assigned to the packets included in the data frames.

To achieve the foregoing objectives, the present disclosure describes a method and system for improving the quality of real time data streaming over a network comprising multiple nodes including a source node, a destination node, and zero or more intermediate nodes. The source node transmits a real time data packet of a data frame to the destination node. Maximum latency of the real time data packet is obtained at the source node. Thereafter, the real time packet is routed from the source node to the destination node through zero or more intermediate nodes such that the real time data packet reaches the destination node before its maximum latency expires. The real time data packet includes information about its maximum latency and this maximum latency information is updated by each intermediate node. Each intermediate node subtracts time spent by the real time data packet at the node from the maximum latency value received at the node.

Another embodiment of the present disclosure, discloses a network comprising multiple nodes (including a source node, a destination node, and zero or more intermediate nodes) that route one or more real-time data packets of one or more data frames, wherein the real-time data packets include information about their maximum latency. The nodes are configured to obtain this maximum latency information. Further, the nodes are configured to route the real time data packets from the source node to the destination node through zero or more intermediate nodes such that the real time data packets reach the destination node before their maximum latency expires. Moreover, the intermediate nodes are configured to update the maximum latency of the real time data packets. Each intermediate node subtracts the time spent by the packet at the node from the maximum latency value received at the node.

### BRIEF DESCRIPTION OF THE FIGURES

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present disclosure

FIG. 1 is a block diagram illustrating a network in accordance with one embodiment of the present disclosure.

FIG. 2 is a block diagram illustrating a node of a network in accordance with one embodiment of the present disclosure.

FIG. 3 is a flowchart illustrating a method for improving the quality of streaming real time data over a network in accordance with one embodiment of the present disclosure.

FIG. 4 is a block diagram illustrating calculation of maximum latency of each packet of data frames sent by source node in accordance with an example embodiment of present disclosure.

FIG. 5 a table illustrating calculation of self-latency for a node in accordance with an exemplary embodiment of the present disclosure.

FIG. 6 a block diagram illustrating calculation of self-latency for a node in accordance with an exemplary embodiment of the present disclosure.

FIG. 7 is a block diagram illustrating latencies for nodes and the use of beacons for latency calculations in a network in accordance with the exemplary embodiment of the present disclosure.

FIG. 8 is a timing diagram illustrating propagation of packets in a network in accordance with an example embodiment of the present disclosure.

FIG. 9 is a block diagram illustrating obtaining MPEG compressed data packets from raw data frames in accordance with an exemplary embodiment of the present disclosure.

FIG. 10 is a table illustrating packets obtained from an MPEG encoder in accordance with an exemplary embodiment of the present disclosure.

FIG. 11 is a table illustrating a packet queue at a node in accordance with an exemplary embodiment of the present disclosure.

FIG. 12 is a flowchart illustrating a method for dropping packets in accordance with an exemplary embodiment of the present disclosure

FIG. 13 is a network illustrating multi-casting of data packets in accordance with an exemplary embodiment of the present disclosure.

FIG. 14 is a data packet of a node of a network in accordance with one embodiment of the present disclosure.

FIG. 15 is an acknowledgment packet sent by nodes in response to receiving a data packet in accordance with one embodiment of the present disclosure.

FIG. 16 is a beacon packet sent by nodes in a network in accordance with one embodiment of the present disclosure.

Those skilled in the art will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

### DETAILED DESCRIPTION

Before describing embodiments of the present disclosure in detail, it should be observed that the embodiments reside primarily in combinations and apparatus components related to network systems and nodes. Accordingly, the apparatus components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In this document, relational terms such as first and second, and the like are used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

A method for improving the quality of real time data streaming over a network comprising multiple nodes is described here. The multiple nodes include a source node, a destination node, and zero or more intermediate nodes. Further, the real time data is transmitted in the form of data frames that include one or more real time data packets (hereafter referred to as data packets), and the data frames and data packets include latency information. The source node transmits the data packets to the destination node. First, the source node obtains maximum latency information of the data packets. Next, the source node and zero or more intermediate nodes route the data packets from the source node to the destination node, such that the data packets reach the destination node before their maximum latency expires. Each intermediate node updates the maximum latency of the packet by subtracting time spent by the packet at the node from the maximum latency value received with the data packet.

### Exemplary Network

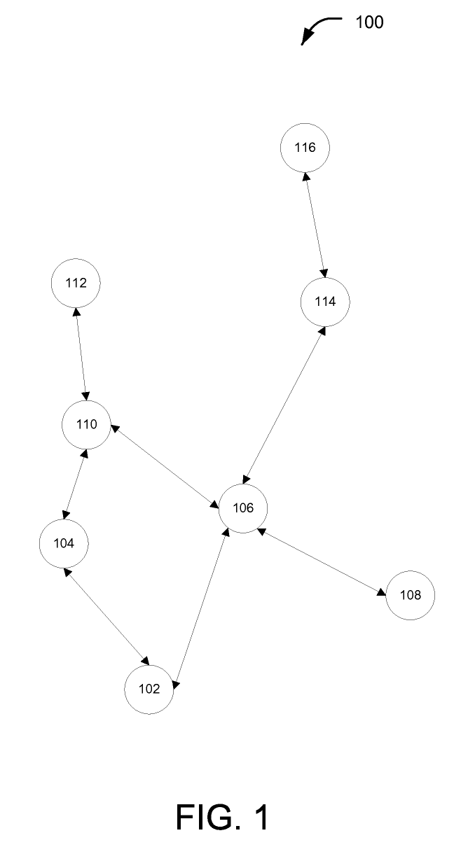

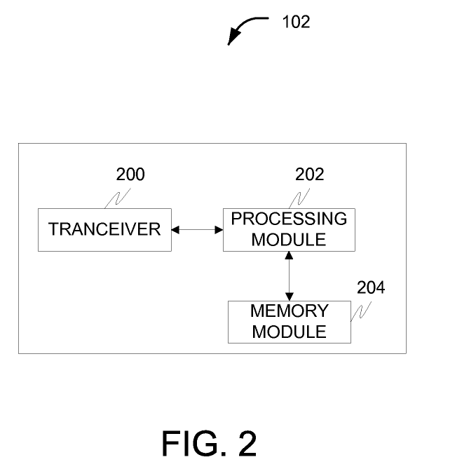

Referring now to the drawings, FIG. 1 depicts a block diagram of a network 100 in accordance with one embodiment of the present disclosure. The network 100 includes multiple nodes capable of sending and receiving data, and routing data packets. The network 100 includes nodes 102-116. However, it should be understood by those of ordinary skill in the art that any number of nodes may be present in the network; for example, organizational networks may include 50-100 nodes, while a network, like the Internet, can include thousands of nodes. Further, the network 100 may be a wired network, a wireless network, or a combination thereof. The lines connecting the nodes depict data transfer paths. The nodes 102-116 can send and receive data only from nodes they share transfer paths with (neighboring nodes). For example, node 106 can receive or send data only to nodes 102, 108, 110, and 114, while node 112 can send data only to its neighbor node, node 110. Each node is represented by a unique node ID. In an embodiment, the node ID is the Media Access Control (MAC) address of the node. Nodes are explained in detail in conjunction with FIG. 2.

The network 100 operates in a typical manner, i.e., one node can be a source node (such as the node 102) transmitting data to a destination node (such as node 116) and intermediate nodes can be selected from the remaining nodes to aid in transferring data from node 102 to 116, based on a number of factors. Factors can include available bandwidth at the nodes, type of data, number of data packets, node location, maximum latency of the data packets, self-latency of the node, and so on. It will be understood that any node in the network can behave as a source node, a destination node, or an intermediate node depending on the situation.

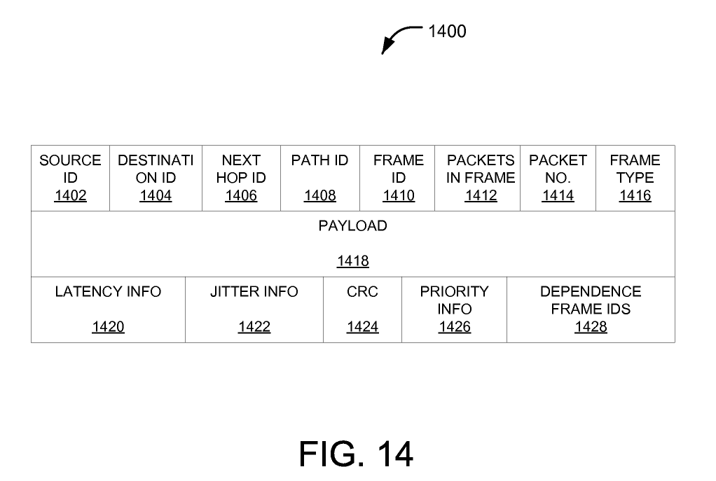

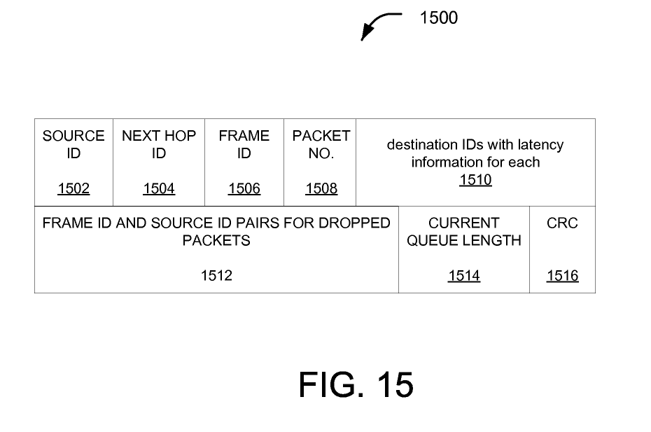

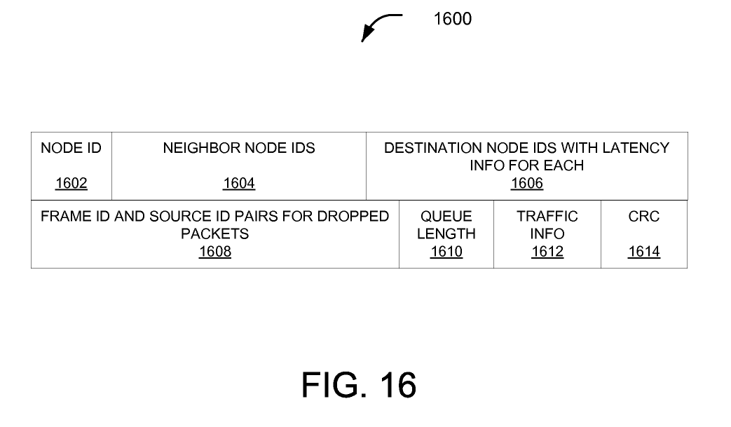

Further, the nodes send/receive data in the form of data frames including one or more data packets. Data packets are explained in detail in conjunction with FIG. 14 later in the disclosure. Moreover, each node sends back an acknowledgement packet when it receives a data packet from its neighbor node. Acknowledgement packets are explained in detail in conjunction with FIG. 15 below. Each node further broadcasts beacon packets to its neighbor nodes. Beacons may be sent periodically or in response to some change in network or latency information. For example, the beacon broadcasted by the node 102 is received by the nodes 104 and 106. Beacons are explained in detail in conjunction with FIG. 16 below.

Each node in the network 100 uses beacons and acknowledgments received from the neighbor nodes to determine latency characteristics for each of its neighbor nodes. The latency characteristics include one or more of: neighbor node IDs, data frame IDs of dropped packets, source IDs of dropped packets, types of dropped packets, priority of dropped packets, destination node IDs with latency information for each destination node, traffic information, or queue length of the node. Each of the latency characteristic will be explained in further detail in conjunction with later figures. Nodes require latency characteristics of its neighbor nodes for routing data packets.

### Exemplary Node

Turning now to FIG. 2, a block diagram illustrating an exemplary node, such as the node 102 in accordance with one embodiment of the present disclosure is described herewith. The node 102 includes a transceiver 200, a processing module 202, and a memory module 204. The transceiver 200 is configured for transmitting and receiving signals. In an embodiment of the disclosure, the transceiver 200 transmits and receives wireless signals using an antenna connected to the node 102. Alternately, the transceiver 200 transmits and receives signals from a wired network. Further, the node 102 may include one or more transceivers. Signals include, but are not limited to, data packets, beacons, and acknowledgements.

The processing module 202 is configured to manage connections with other nodes in the network 100. The memory module 204 is configured to store the latency characteristics of the node 102, the latency characteristics of the neighbor nodes, data packets generated by the node 102, data packets to be forwarded to the neighbor nodes, acknowledgments received from neighboring nodes and beacon packets. The node 102 may further include a battery to provide power to the various modules in the node 102.

### Exemplary Method(s)

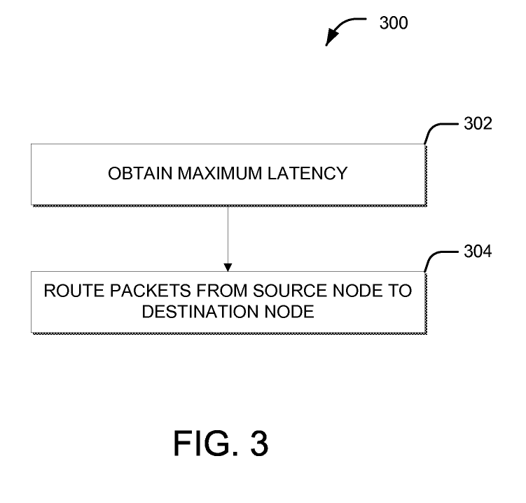

Turning now to FIG. 3, a flowchart illustrating a method 300 for improving the quality of streaming real time data over the network 100 in accordance with one embodiment of the present disclosure is described herewith. The method 300 includes the steps of obtaining a maximum latency for data packets and data frames, and routing data packets from source node to destination node so that the packets reach the destination node before the maximum latency of the packets expires.

A source node, such as the node 102 transmits real time data packets to a destination node, such as node 116. The real time data may include for example, live sports matches, news, award shows, teleconferences, Microsoft® live meetings, and so on. As mentioned previously, the real time data is transmitted in the form of multiple data frames. The data frames may include raw data frames, or compressed data frames. For example, the MPEG format uses compressed data frames for videos. In an exemplary embodiment of the present disclosure, the source node (such as the node 102) encodes individual video data frames of the real time data into MPEG packets before sending to the destination node 116.

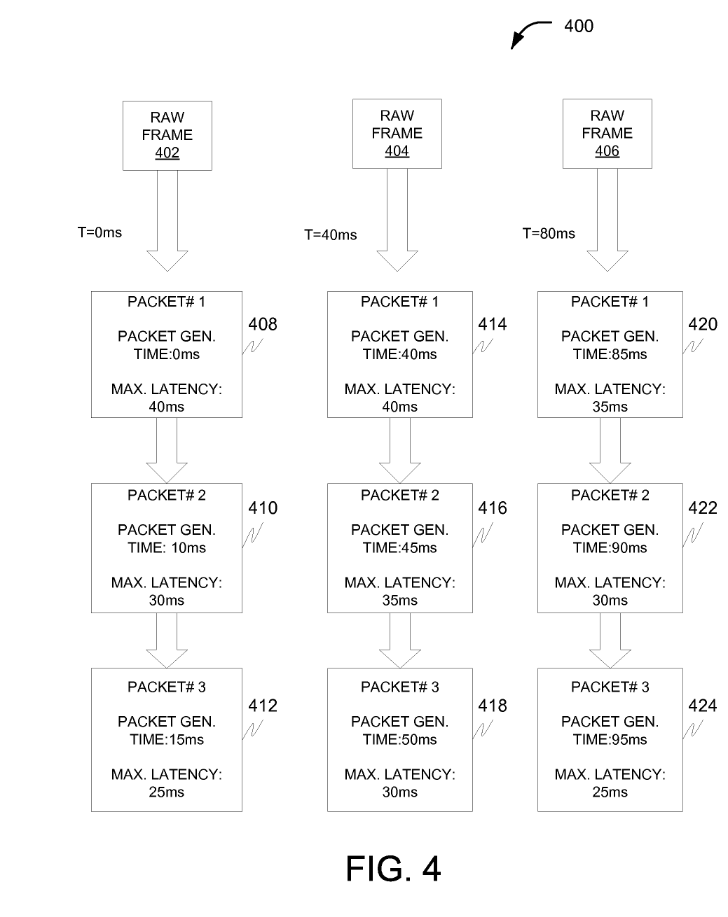

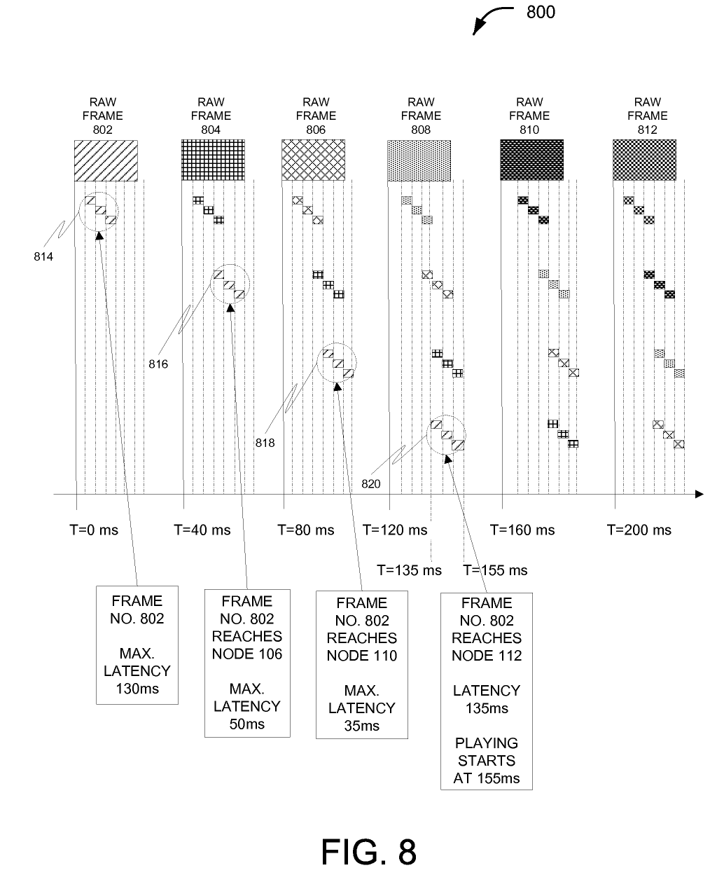

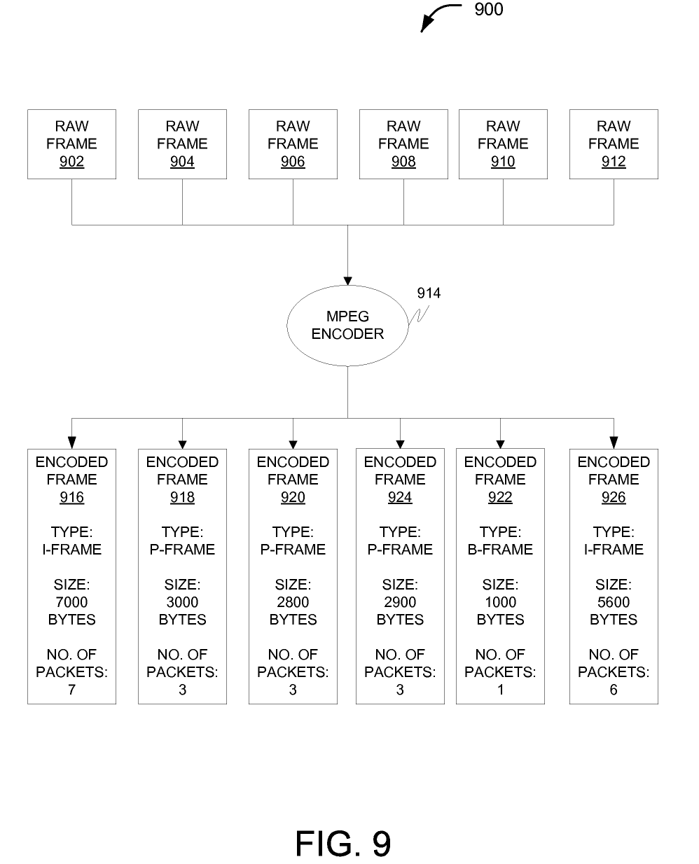

Moving on, the source node 102 splits the data frames into multiple data packets before sending the real time data to the destination node 116. The splitting of data frames into multiple data packets is illustrated in FIG. 9. At step 302, the source node 102 determines the maximum latency of the data packets. The source node may determine maximum latency based on the latency between data packets (inter-packet latency) and the latency between data frames (inter-frame latency). This is explained in detail in conjunction with FIG. 4 below. Further, the source node may determine the maximum latency information based on neighbor node latency information. This is explained in detail in conjunction with FIG. 8 below.

Thereafter, at step 304, the one or more data packets are routed from the source node 102 to the destination node 116 through zero or more intermediate nodes so that the data packets reach the destination node 116 before their maximum latency expires. At the destination node 116, all the data packets of a data frame must reach within a time duration defined by maximum latency so that the original data frame can be reconstructed. If any packet is delayed beyond its maximum latency, the other packets of the same frame are also rendered useless. For example, for a raw video streaming application, the video source may be generating a data frame every 40 ms for a 25 fps video. In this situation, all the data frame packets must reach the destination within 40 ms so that the data frame can be properly reconstructed at the destination node. Even if one packet of a data frame is delayed beyond 40 ms, the destination node 116 will not be able to reconstruct that data frame in the stipulated time; thereby rendering even the packets that reached the destination on time useless. Therefore, the intermediate nodes must ensure that all the packets of a data frame reach before the maximum latency of the packet expires, so that freezing of frames is minimized at the destination node 116. To this end, the source or the intermediate nodes determine the best route to the destination node so that the data reaches before the maximum latency expires.

In one embodiment of the present disclosure, the source node determines the best route to the destination node, and places this information in the packet before transmission. The data packet then follows this route. The source node can make this decision based on a number of factors such as maximum latency of the packet, latency of nodes, queuing time at each node, number of nodes between source and destination, priority of packets, and so on. At each node, latency characteristics of neighboring nodes are determined using beacons and acknowledgments received from the one or more neighboring nodes. The nodes maintain a database of this information, which is stored in the node memory. Further, the node latency characteristics can be updated in real time or at predetermined intervals of time. Whenever a source node, such as the node 102 has to transfer a packet to the destination node (node 116), the source node analyses this information along with maximum latency information, and destination node ID to decide the best routing path for the packet. For example, the source node (node 102) determines that routing the packet through the nodes 106 and 114 is better than routing through nodes 104, 110, 106, and 114, and routes the packet to node 106, which in turn routes the packet to the node 114.

In another implementation, the source node selects only the next hop node and route the packet to that node. The next node analyzes the data packet characteristics, like latency, priority etc., and neighboring node characteristics to select the next best node for routing the packet. In this manner, the packet path is not predetermined at the source, but each node determines the next hop node. Further, multiple packets of an individual data frame may be routed to the destination node 116 over different paths based on the next node analysis.

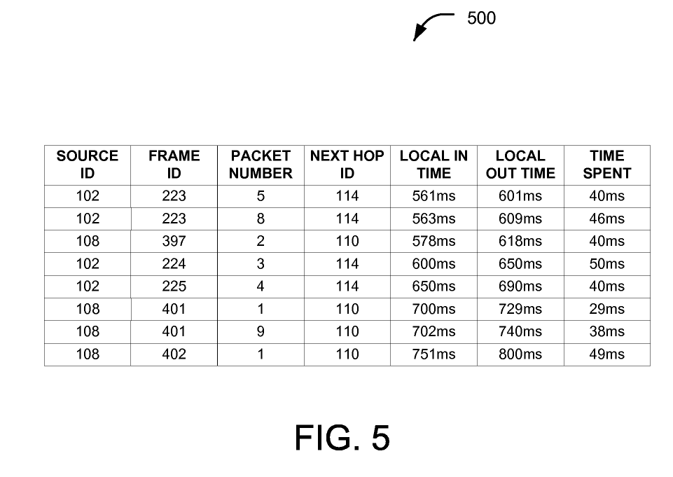

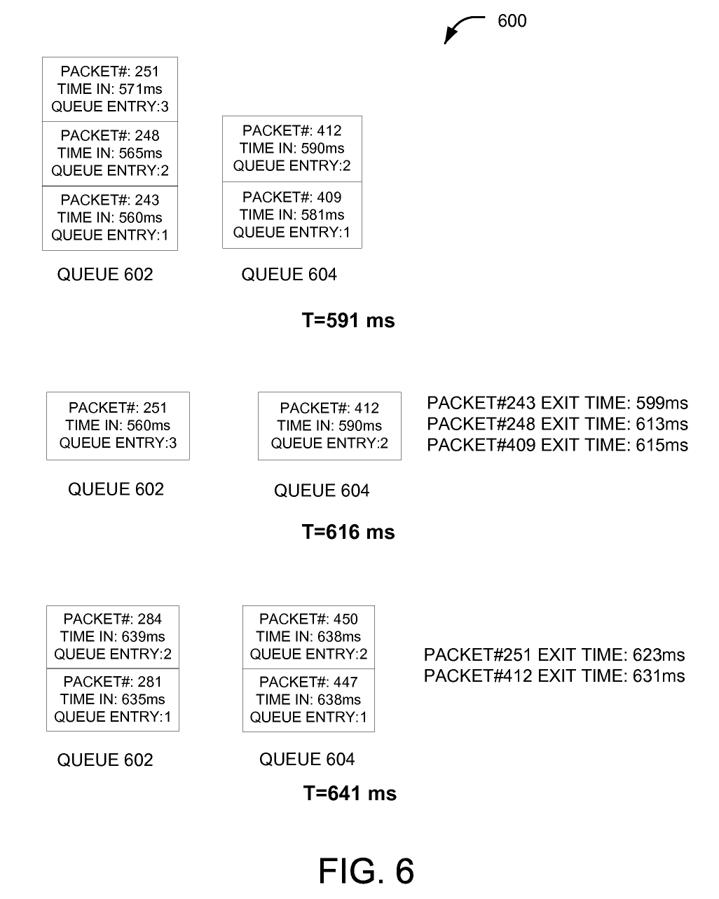

Each of the intermediate nodes, such as nodes 106 and 114, through which the packet is routed, updates the maximum latency of the packet. The intermediate nodes subtract time spent by the packet at the node from the maximum latency value received along with the packet. In an embodiment, each node marks the time when the packet is received at the node and the time when the packet is routed from the node. Before sending the packet to the next node, each node uses the marked time to calculate the time spent by the packet in the node. The time spent by packets at a node is known as self-latency of the node and it is calculated separately for each neighbor. Self-latency may be calculated over a period using various methods. FIG. 5 and FIG. 6 below illustrate two methods to calculate self-latency of a node.

The remaining disclosure document describes the concepts introduced with respect to FIG. 1-3 in detail. These concepts include maximum latency, methods to calculate self-latency of a node, packet propagation through the nodes, packetization, priority and dependence, packet dropping, multicasting, data packets, beacons, and acknowledgements.

### Packet Maximum Latency Calculation

FIG. 4 depicts a block diagram 400 illustrating calculation of maximum latency for each packet sent by the source node (such as the node 102) in accordance with an embodiment of the present disclosure. In this exemplary embodiment, frame rate of the transmitted video is 25 fps. Therefore, the source node 102 generates a frame every 40 ms. At time t=0 ms, the source node 102 generates a raw data frame 402. Next at time t=40 ms, the source node 102 generates a next raw data frame 404 and then at time t=80 ms, a next raw data frame 406 is generated. The maximum latency between data frames (inter-frame latency) is, therefore, 40 ms. Maximum latency may be calculated based on latency of neighbor nodes of the source node. This is explained in detailed in conjunction with FIG. 8 below.

Before sending the data frames over the network, the source node converts the raw data frames 402, 404, and 406 into data packets. In order to explain this process, each data frame in this example is divided into three packets, however, it will be understood that the data frames can be divided into any number of data packets without departing from the scope of the present invention. At time t=0 ms, the source node 102 creates a data packet 408, for the data frame 402, and includes the data packet's maximum latency information (40 ms) in the packet. Similarly, the source node 102 creates the second packet 410 for the raw data frame 402. The second data packet 410 is created after a lapse of 10 ms, and since all data packets must reach the destination in 40 ms, the maximum latency calculated for the data packet 410 is 30 ms. The source node 102 takes 15 ms, from t=0 ms, to create the third packet 412, therefore, the maximum latency for the packet 412 is 25 ms.

Then, at time t=40 ms, the source node 102 starts generating packets for the raw data frame 404. The source node 102 creates the three data packet 414, 416, and 418 at times t=40 ms, t=45 ms, and t=50 ms; therefore, the maximum latency for the three data packets 414, 416, and 418 is 40 ms, 35 ms, and 30 ms respectively. Then, at time t=80 ms, the source node 102 starts generating packets for the raw data frame 406. The three data packets 420, 422, and 424 are created at times t=85 ms, t=90 ms, and t=95 ms; therefore, their maximum latency times become 35 ms, 30 ms, and 25 ms respectively. The maximum latency information corresponding to each data packet is placed in the packet for easy manipulation by intermediate nodes.

### Method(s) for Calculating Self-Latency

Turning now to FIG. 5, a table 500 illustrating calculation of self-latency at the node 106 using a first method in accordance with an exemplary embodiment of the present disclosure is described herewith. Self-latency at a node (such as the node 106) is the average of the latency encountered at the node 106, while transmitting data packets to a neighbor node, in a predetermined time interval. In this method, the node calculates self-latency by marking both the local times when the node 106 receives a packet and transmits it. The time difference between the two local times is the self-latency of the node 106. Then all the self-latency times of the node 106, while transmitting packets to a particular node, are averaged to obtain the self-latency of the node for that particular neighbor node. Similarly, the node 106 can calculate self-latency with respect to all its neighboring nodes. This is done for each of the neighbor nodes 102, 108, 110 and 114. However, as the node 106 is not forwarding any packets to the nodes 102 and 108 in the example embodiment, self-latency for these two nodes cannot be calculated.

In this example embodiment, in one time interval, the node 106 forwards 4 packets to the node 110 (packet numbers 2, 1, 9, 1) and 4 packets to the node 114 (packet numbers 5, 8, 3, 4). The nodes 110 and 114 may not be the destination nodes for the data being forwarded. For example, the packets forwarded to the node 110 may be destined for node 112 and packets being forwarded to the node 114 may be destined for the node 116. The time spent by the node 106 for transmitting packet number 2 to the node 110 is 40 ms. Similarly, the time spent by the node 106 for transmitting remaining three packets with packet numbers 1, 9 and 1 to the node 110 is 29 ms, 38 ms and 49 ms respectively. Therefore, the total time spent by the node 106 for transmitting data to the node 110 is 156 ms and the average of this value provides the self-latency of the node 106 for the node 110 as 39 ms. On the other hand, the total time spent for forwarding packets to the node 114 is 176 ms and an average of this value provides the self-latency to the node 114 as 44 ms.

Similarly, all nodes in the network 100 can determine their self-latency information. The node 110 may report in its beacon its latency to the node 112 as 38 ms. The node 106 on getting this beacon calculates that its latency to the node 112 is 38 ms (from the node 110)+39 ms (self-latency of node 106 for node 110)=77 ms. Similarly, the node 114 may report in its beacon its latency to the node 116 as 31 ms. The node 106 will then calculate its latency to the node 116 as 31 ms (from the node 114)+44 ms (self-latency of node 106 for node 114)=75 ms.

Therefore, the beacon for the node 106 will include latencies of 77 ms and 75 ms to the nodes 112 and 116 respectively. The beacon for the node 106 may also include latencies of 39 ms and 44 ms to the nodes 110 and 114 respectively. The node 106 sends this information in its beacons to all the neighboring nodes. Each node in the network 100 performs these activities. Further, the node 106 sends this information in acknowledgements for received data packets to the neighboring nodes.

FIG. 6 is a block diagram 600 illustrating self-latency calculation for nodes 110 and 114 using a second method in accordance with an exemplary embodiment of the present disclosure. Each node maintains a queue for each of its next hop neighbors and calculates its self-latency for these nodes by examining these queues. For example, the node 106 maintains different queues for its next hop neighbors i.e. the nodes 110 and 114. FIG. 6 shows exemplary queues (a queue 602 and a queue 604) at the node 106 corresponding to the nodes 110 and 114 respectively at three different instances of time, i.e. t=591 ms, t=616 ms and t=641 ms. The node 106 calculates its self-latency for both the nodes 110 and 114 separately by examining the corresponding queues. The node 106 stores the time at which a packet enters a queue (one of the queue 602 and the queue 604) and the position at which it is inserted into the queue. This information can be used by node 106 to determine queue moving time, i.e., the average time taken for a packet to move one position in queue, using equation 1:

Queue moving time at any instant=Sum of time spent by packets in queue/Total no. of positions moved by these packets in the queue (1)

Self-latency of a node corresponding to the next hop neighbors is calculated based on the queue moving time and current queue length. This self-latency is added to the latency received previously from beacons to determine the current latency.

At time t=591 ms, the queue 602 has three packets (packet #243, 248 and 251) in its queue and the queue 604 has two packets (packet #409 and 412). At time t=616 ms, three of the packets (2 from the queue 602 and 1 from the queue 604) have been transmitted. Therefore, at time t=616 ms, the queue length of both the queue 602 and the queue 604 is 1. The packet#243 is transmitted at time t=599 ms. The packet#248 is transmitted at time t=613 ms and the packet#409 is transmitted at time t=615 ms.

Using equation (1) we obtain:

Queue moving time for the queue 602=((599−560)+(613−565))/3=29 ms

Queue moving time for the queue 604=(615−581)/1=34 ms

The node 110 may report in its beacon its latency to the node 112 as 38 ms. The node 106 on getting this beacon calculates that its latency to the node 112 is 38 ms (from the node 110)+29×1(Queue length)=67 ms. Similarly, the node 114 may report in beacon its latency to the node 116 as 31 ms. The node 106 will then calculate its latency to the node 116 as 31 ms (from the node 114)+34×1 (Queue length)=65 ms.

These queue-moving times provide a measure of the self-latency at the node 106 for the nodes 110 and 114.

At time t=641 ms, the node 106 includes two new packets (packet #284 and 281) in the queue 602, and two new packets (packet #450 and 447) in the queue 604. At time t=641 ms, two of the packets (one from the queue 602 and one from the queue 604) have been transmitted. The packet#251 is transmitted at time t=623 ms and the packet#412 is transmitted at time t=631 ms. Therefore, at time t=641 ms, the queue lengths of both the queue 602 and the queue 604 is 2.

Using equation (1) again, we obtain:

Queue moving time for the queue 602=((599−560)+(613−565)+(623−560))/6=25 ms

Queue moving time for the queue 604=((615−581)+(631−590))/3=25 ms

The nodes can calculate self-latency whenever a beacon is to be sent or whenever an acknowledgement is being sent.

Again, the node 110 may report in its beacon its latency to the node 112 as 38 ms. The node 106 on getting this beacon calculates that its latency to the node 112 is 38 ms (from the node 110)+25×2(Queue length)=88 ms. Similarly, the node 114 may report in beacon its latency to the node 116 as 31 ms. The node 106 will then calculate its latency to the node 116 as 31 ms (from the node 114)+25×2 (Queue length)=81 ms.

Network with Node Latencies

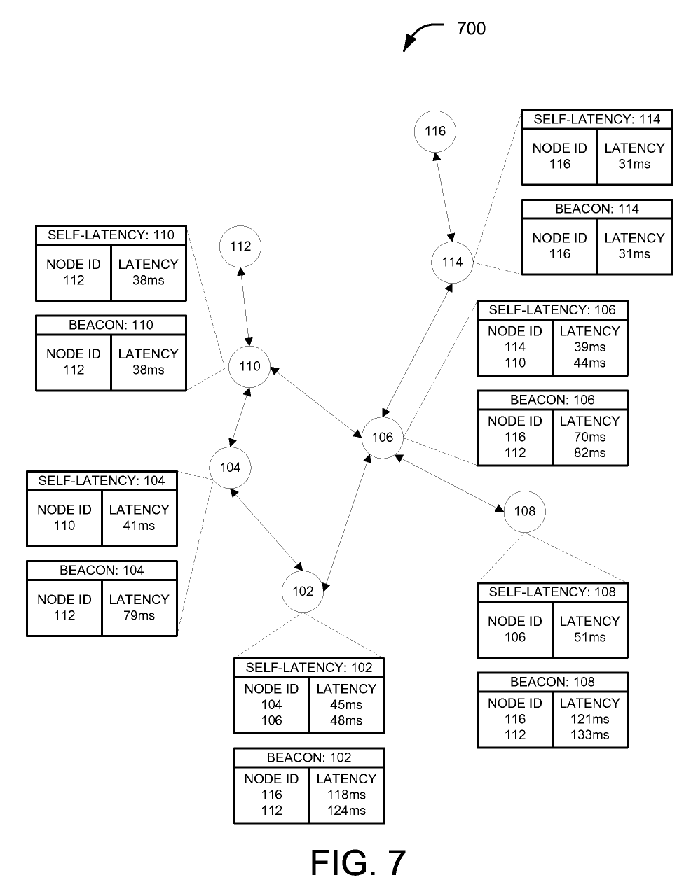

Turning now to FIG. 7, a block diagram 700 illustrating latencies for nodes and the use of beacons for latency calculations in the network 100 in accordance with the exemplary embodiment of the present disclosure is described. FIG. 7 depicts the nodes in the network along with their calculated self-latency tables and their beacons. The self-latency tables for each node include its latency to the next hop neighboring nodes. For example, the self-latency table for the node 102 depicts its self-latency to the nodes 104 and 106. This self-latency is calculated using the methods described in conjunction with FIG. 5 and FIG. 6. In the beacon signal, the node only sends its latency to the destination nodes (in this example—the nodes 112 and 116). However, for the nodes 110 and 114, the neighbors are also the destination nodes. Hence, for these nodes self-latency and the latency propagated in the beacons is same.

For example, the node 108 gets a beacon from the node 106 indicating a latency of 70 ms to node 116 and 82 ms for the node 112. It calculates that its own latency to the node 106, which is its only next hop neighbor node, is 51 ms. Therefore, in its beacon, the node 108 propagates that its latency to node 116 is 70 ms (from the node 106 beacon)+51 ms (self-latency of the node 108 to the node 106)=121 ms and that to the node 112 is 82 ms (from the node 106 beacon)+51 ms (self-latency of the node 108 to the node 106)=133 ms.

Further, as the node 102 has multiple paths to reach the node 112, one through the node 106 and the other through the node 104, it propagates the least latency it can provide in its beacon. The node 102 may further use some criteria other than the least latency for deciding which of the latency information is included in its beacon. For example, the latency from the node 106 is 82 ms (from node 106 beacon)+48 ms (node 102 self-latency)=130 ms. On the other hand, the latency to the node 112 through the node 104 is 79 ms (from node 104 beacon)+45 ms (node 102 self-latency)=124 ms. Therefore, 124 ms is the latency value propagated in the beacon of node 102 for the node 112. For node 116, node 102 has just a single path, through node 106. Hence, its latency value is calculated as 70 ms (from node 106 beacon)+48 ms (node 102 self-latency)=118 ms. The beacons and self-latency tables for each node are stored in the memory module of the node. Nodes can examine this information to decide the best possible route to the destination node.

### Packet Propagation

FIG. 8 is a timing diagram 800 illustrating packet propagation in the network 100 in accordance with an exemplary embodiment of the present disclosure. The FIG. 8 includes six data frames 802, 804, 806, 808, 810, and 812, which are generated by the source node 102 from a 25 fps (40 ms) video. The node 112 is the destination node for all the data frames 802-812. Each of the data frames are converted into three packets, which are generated 5 ms apart. In the FIG. 8, each dashed line corresponds to 5 milliseconds. The three packets for 802 are shown by 814.

Packets from the node 102 can reach the node 112 through either path 102-106-110-112 or path 102-104-110-112. For the node 102, the latency through route 102-106-110-112 is sum of latency received in beacon of the node 106, which is 82 ms for the node 112 (from FIG. 7), and the self latency of the node 102 for the node 106, which is 48 ms (from FIG. 7). Therefore, the latency value is 82 ms+48 ms=130 ms.

Similarly, the latency through route 102-104-110-112 is sum of latency received in beacon of the node 104, which is 79 ms for the node 112, and the self-latency of the node 102 for the node 104, which is 45 ms. Therefore, the latency value is 79 ms+45 ms=124 ms.

In a further embodiment, the node 102 uses both these paths to send data to the node 112. In this embodiment, the maximum latency is calculated based on latency value of both paths, as the latency value of both paths is greater than the inter-frame latency of 40 ms. The maximum latency of the data packets in this embodiment should be greater than the latency value of both the paths, i.e., the maximum latency of the data packets should be 130 ms. Since a new frame is generated every 40 ms, the maximum allowance on the latency can be 40/2=±20 ms. To keep some headway, the node 102 may add a jitter tolerance of 15 ms in the data packet jitter information (explained in further detail in conjunction with FIG. 14 below).

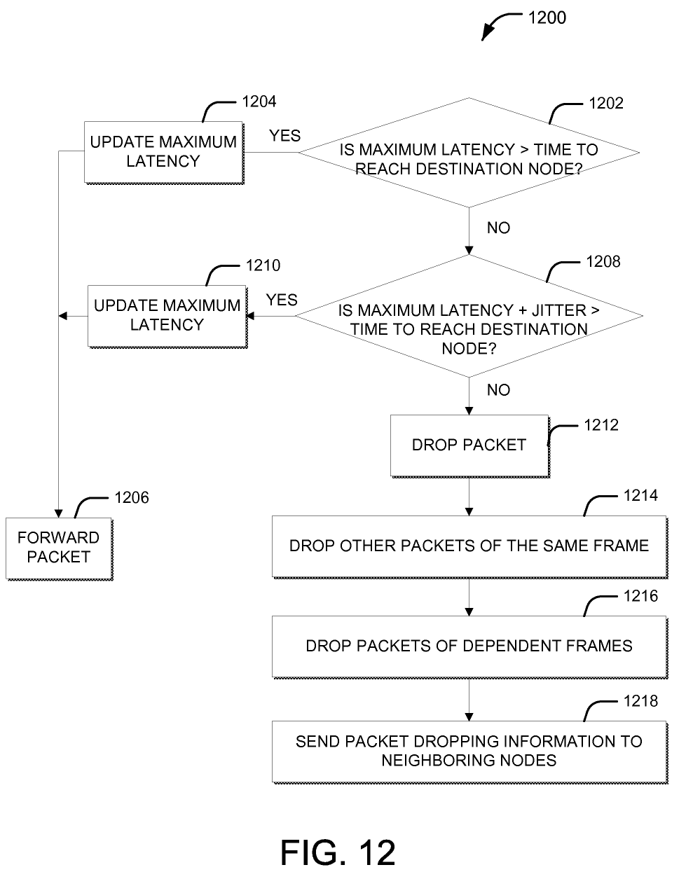

Exemplary packet propagation will be explained in the following paragraphs with reference to FIG. 8. The node 102 sends frames 802, 806, and 810 through the path 102-106-110-112 and the data frames 804, 808 and 812 through 102-104-110-112. For the frame 802, the node 102 marks 130 ms as the maximum latency as shown by 814. Suppose all the packets of the frame 802, take 50 ms in the queue at the node 102. Therefore, before transmission, the node 102 changes the maximum latency value in the packets from 130 ms to 80 ms (=130 ms−50 ms). As shown by 816, all the packets of the frame 802 reach the node 106 50 ms after generation. The maximum latency value in each of these packets is 80 ms. If these packets spend 45 ms in the queue at the node 106, then the node 106 modifies the maximum latency for each of these packets to 35 ms (=80 ms−45 ms), before transmission. Therefore, as shown by 818, these packets reach the node 110, with a maximum latency value of 35 ms. The sum of the latency encountered by each of the packets of the frame 802 is 50 ms (node 102)+45 ms (node 106)=95 ms. Therefore, a packet generated at time t=5 ms reaches the node 110 at t=5 ms+95 ms=100 ms, as shown by 818. The node 110 has a latency of 38 ms for the node 112 (from FIG. 7). However, the maximum latency of the packets it has received is 35 ms. Nevertheless, the jitter tolerance of ±15 ms is allowed for the packets of the data frame 802; therefore, the maximum latency of 35 ms+15 ms=50 ms can be allowed. Since this value is more than the latency for the node 110 to reach the node 112, the node 110 forwards the packets to the node 112. In case the value obtained after combining maximum latency and jitter is less than the latency for the node 110 to reach the node 112, the node 110 drops the packets. This is explained in further detail in conjunction with FIG. 12 below. If the packets take 40 ms in the queue at the node 110, then they reach the node 112 after a latency of 50 ms (node 102)+45 ms (node 106)+40 ms (node 110)=135 ms. So the last packet of the frame 802, which was generated at t=15 ms reaches the node 112 at 15 ms+135 ms=150 ms. The node 112 can start playing the data at t=155 ms after all the packets have reached, as shown by 820.

Now suppose the packets of the frame 804 encounter a latency of 45 ms at the node 102, 45 ms at the node 104 and 40 ms at the node 110. Then the packets reach the node 112 after a latency of 45 ms+45 ms+40 ms=130 ms. So the last packet of the frame 804, which was generated at t=55 ms, reaches the node 112 at t=185 ms. As the node 112 started playing the frame 802 at t=155 ms, it needs the next frame at t=155 ms+40 ms=195 ms (as the inter-frame latency is 40 ms). Hence, the second frame has reached well in time for the video to be played out continuously.

Similarly all packets of the frame 806 reach the node 112 by time t=235 ms. The frame 806 will be required at time t=155 ms+80 ms=235 ms. Hence, the video is played continuously without any stops.

### Data Packetization, Priority, Dependence

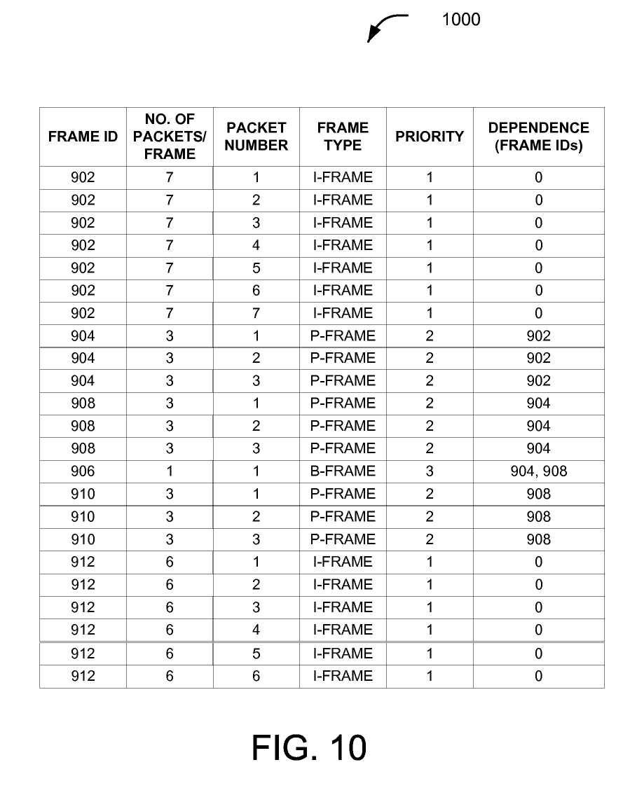

The next two figures (FIG. 9 and FIG. 10) are employed to explain creation of data packets, priority assignment, and dependence assignments. FIG. 9 is a block diagram 900 illustrating creation of MPEG compressed data packets from raw data frames in accordance with an exemplary embodiment of the present disclosure. Raw data frames 902, 904, 906, 908, 910, and 912 are encoded into the MPEG format by an MPEG encoder 914. This process is widely known in the art, and is restated here, merely to explain the association between data frames and data packets. The MPEG format uses four types of video data frames—I-frames, P-frames, B-frames and D-frames. Typically, D-frames are rarely used. I-frames are intra-coded data frames and they are stand-alone data frame. I-frame does not rely on other data frames for re-constructing the original data frame. P-frames are predicted data frames, which are coded relative to the nearest I-frame or P-frame. B-frames are bi-directional data frame that are reconstructed using the closest past and future I-frame or P-frame as reference. Therefore, P-frame and B-frames depend at least to some extent on I-frames for reconstruction at the receiver.

The MPEG encoder 914 produces an encoded frame 916 for the raw data frame 902. The encoded frame 916 is an I-frame that includes 7 packets of total size 7000 bytes. In the example embodiment, 1000 bytes is taken as the packet size. However, the packet size may vary widely. Further, output of the MPEG encoder may vary from the one described in the example embodiment. Similarly, the MPEG encoder 914 produces an encoded frame 918 for the raw data frame 904; the encoded frame 918 is a P-frame that includes 3 packets of total size 3000 bytes. Encoded frame 920 illustrates 3 P-frame data packets of total size 2800 bytes. These data packets are derived from the raw frame 908. Similarly, encoded frames 922, 924, and 926 depict creation of B, P, and I frame data packets for the data frames 906, 910, and 912 respectively.

Turning now to FIG. 10, a table 1000 illustrating packets obtained from the MPEG encoder 914 in accordance with an exemplary embodiment of the present disclosure is described herewith. The table 1000 depicts the order in which the packets are formed after the MPEG encoder 914 compresses the raw data frames 902, 904, 906, 908, 910, and 912. The table 1000 further illustrates the priority and dependence values assigned to each of the data packets. All the packets of a particular frame are assigned the same priority. Further, packets corresponding to I-frames are assigned the highest priority of 1. Packets corresponding to P-frames are assigned the second highest priority of 2 and packets corresponding to B-frames are assigned the lowest priority of 3. The dependence value of ‘0’ indicates that the packet is not dependant on any other frame. So, all packets corresponding to I-frames will have dependence values of ‘0’. Dependence values other than ‘0’ indicate the frames on which the current frame is dependant. As each P-frame is dependent on an immediately preceding I-frame or P-frame, their dependence values will indicate nearest I-frame ID or P-frame ID; for example, packets of the frame 904 will depend on the frame 902. Similarly, each B-frame is dependent on an I-frame and a P-frame. For example, the packet corresponding to the frame 906 has dependence values of 904 and 908, indicating the packets are dependent on the frames 904 and 908.

### Node Queues

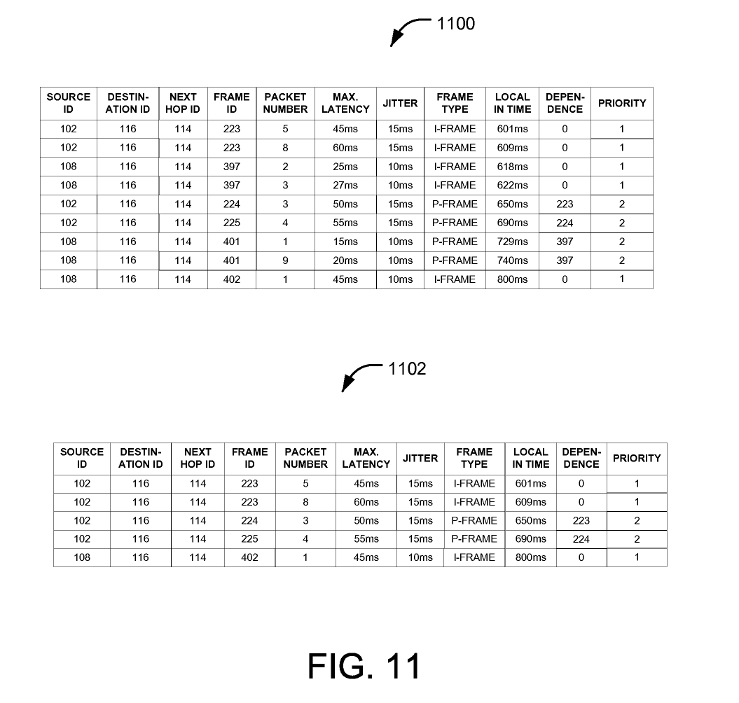

Turning now to FIG. 11, a table 1100 illustrating packet queue at the node 106 in accordance with an exemplary embodiment of the present disclosure is described herewith. For each packet in the packet queue, the table 1100 shows information that includes source ID of each packet, destination ID, next hop ID, frame ID and type of frame each packet belongs to, maximum latency, jitter for each packet, local in-time at the node 106, dependence values of each packet, and priority of each packet. The destination node for the packets in the queue is node 116 and the latency of node 106 for node 116 is 70 ms (FIG. 7).

As depicted in the table 1100, packet#2 of frame ID 397 originated at node 108 and has a maximum latency of 25 ms. The allowable jitter time is 10 ms. This means that the maximum latency permissible for this packet is 25 ms+10 ms=35 ms. As the latency for reaching the node 116 is much greater than the maximum latency permissible, the node 106 drops this packet. Packet dropping is explained in further detail in conjunction with FIG. 12 below. Further, as the node 106 drops this packet, it drops all other packets pertaining to the same frame ID (the frame ID 397) and the source ID (source ID 108); therefore packet#3 is also dropped. Moreover, packets of the frame ID 401 depend on the frame ID 397 and are transmitted by same source node (source ID 108); therefore, these packets are also dropped. After dropping these packets, the node 106 also sends information about the dropped frame IDs and source IDs to all its neighboring nodes using beacons and acknowledgments. If any packets corresponding to these frame IDs and source IDs, or depending on these frame IDs with source IDs reach any of the neighboring nodes, they are also dropped.

Table 1102 depicts the queue after dropping the frames. As seen, all packets corresponding to the frame IDs 397 and 401 have been dropped from the queue.

In a further embodiment, priorities are assigned to each data frame in the table 1100, wherein the priority of the data frames is further assigned to the packets of the data frame. The higher priority data frames are linked to lower priority data frames, such that the lower priority data frames are dependent on higher priority data frames. At each intermediate node, higher priority packets with lowest maximum latency value are transmitted first. This may be accomplished by making higher priority packets jump ahead of lower priority packets in the queue at the intermediate nodes. For example, packet#2 of frame ID 397 will be transmitted first, even though packet#5 of frame ID 223 is first in the queue, as packet#2 has highest priority and lowest maximum latency in its priority group. It can be seen that packet#1 of frame ID 401 has a lower maximum latency than packet#2 of the frame ID 397, but it will not be transmitted before packet#2 of the frame ID 397 as it has a lower priority.

In yet another embodiment, the node drops lower priority packets if higher priority packets are dropped. For example, if the node 106 drops packet#2 of the frame ID 397, it also drops other lower priority data frames. After dropping the packets, the node 106 also sends in its beacon that the packets of the frame ID 397 from the source ID 108 should be dropped. In response, the other nodes drop packets corresponding to either this frame or lower priority frames.

In a further embodiment, in case there are packets from different source nodes with same value of maximum latency and associated priority, then packets of those data frames are forwarded first which have lesser number packets in the queue of the node. For example, the packet queue at the node 106 has data packets (packet#5 and packet#8) corresponding to frame 223 with source ID 102 and associated priority of 1. Also, the packet queue at the node 106 has a data packet (packet#1) corresponding to data frame 402 with source ID 108 and associated priority of 1. Although the maximum latency of packet#5 (frame ID: 223 and source ID 102) and packet#1 (frame ID 402 and source ID 108) is same, and so is the priority, the node 106 forwards the packet#1 before the packet#5 and the packet#8, as the number of packets for the data frame 402 are lesser than those for the data frame 223.

### Packet Dropping Criteria

The intermediate nodes can drop certain packets en route to the destination node. FIG. 12 depicts a flowchart 1200 describing the policies for dropping packets. At step 1202, the node 106 determines if the maximum latency of a data packet is greater than estimated time to reach a destination node. The data packet is at the node 106 at the time of consideration; therefore, in this embodiment the node 106 is referred to as the current node 106. If the maximum latency of the packet is greater than the estimated time to reach the destination, the current node 106 does not drop the packet, instead updates the maximum latency of the packet at step 1204 and forwards it to the next node in the path at 1206. If the maximum latency of the packet is lower than the estimated time to reach destination, the current node 106 determines if the sum of maximum latency and jitter time is greater than the estimated time to reach the destination at step 1208. In case the sum is greater than the estimated time, the current node 106 updates the packets maximum latency field at step 1210 and forwards the packet to the next node at step 1206. After update at step 1210, the maximum latency may be negative. For example, if the maximum latency is 35 ms, jitter is 10 ms and the latency encountered at a node is 40 ms. Therefore, the sum of maximum latency and jitter time is 45 ms. However, the packet is still forwarded as the sum of maximum latency and jitter time (45 ms) is greater than the latency encountered (40 ms). The maximum latency after update at step 1210 will be 35 ms−40 ms=−5 ms.

If the sum of maximum latency and jitter time is also lower than the estimated time, the current node 106 drops the packet at step 1212, thereby preventing unnecessary network utilization. At step 1214, the current node 106 determines if any other packets of the same frame ID and source ID are present in the node queue. If yes, then the current node 106 drops other packets with the same frame ID and source ID as well. At the next step 1216, the current node 106 determines if any packets present in the queue depend on the dropped frame. If yes, the current node 106 drops all the dependent packets as well. The current node 106 then sends data frame drop information including the data frame ID and the source node ID to neighboring nodes (the nodes 102, 108, 110 and 114) at step 1218. If any data packets from the dropped frame reach any of the neighboring nodes 102, 108, 110 and 114, those packets are dropped.

### Data Multicasting

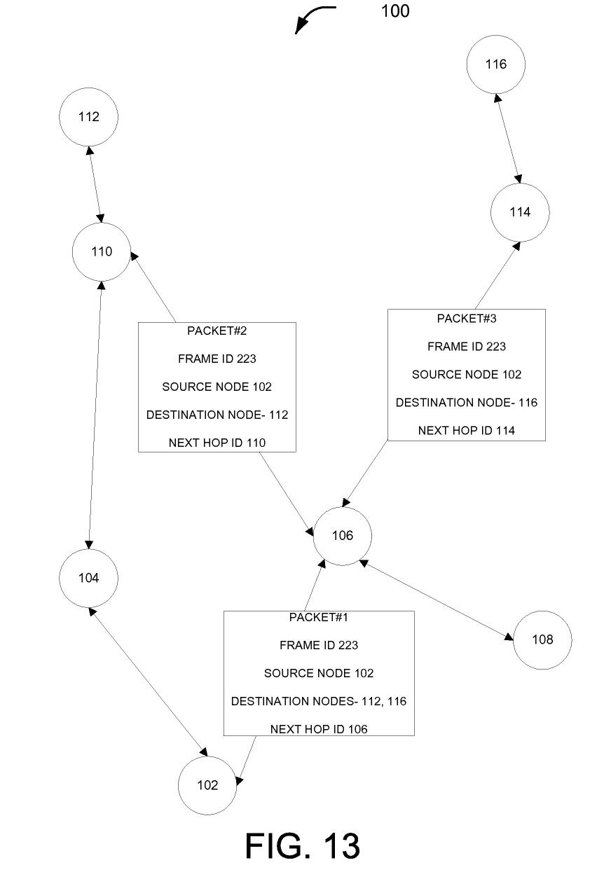

Turning now to FIG. 13, the network 100 illustrating multi-casting of data packets in accordance with an exemplary embodiment of the present disclosure is described herewith. The node 102 has to send a common video frame (frame ID 223) to both the node 112 and the node 116. The node 102 has multiple paths to the node 112, but just a single path to the node 116. Therefore, the node 102 splits the common video frame into data packets. The node 102 then sends a packet (packet#1) to next hop node 106, with both the node 112 and the node 116 as destination nodes. The node 106 on receiving the packet#1 checks if the next hop for the node 112 and the node 116 is common. As this is not the case, the node 106 converts the single packet (the packet#1) into multiple packets (packet#2 and packet#3). Then the node 106 sends the packet#2 to next hop node 110 with the node 112 as the destination node and the packet #3 to next hop node 114 with the node 116 as the destination node. This saves bandwidth as the node 102 does just a single transmission instead of two transmissions.

### Data Packet

The next three figures (FIG. 14, FIG. 15 and FIG. 16) are employed to explain various types of packets used in the network 100. It will be understood that the FIG. 14, FIG. 15, and FIG. 16 are for illustration only. Fields may be added or removed from the FIGs as required. In addition, the FIGs are not drawn to scale and the different sizes of the fields should not be construed as relative sizes of the fields. The order of the fields in the figures is also for illustration only and it does not provide any information about the relative importance of the fields. Turning now to FIG. 14, a data packet 1400 of a node of the network 100 in accordance with one embodiment of the present disclosure is described herewith. The data packet 1400 of a node includes one or more of source node ID 1402 of the node, destination node ID 1404, next hop ID 1406, path ID 1408, frame ID field 1410, packets in frame 1412, packet no. 1414, frame type 1416, payload 1418, latency info 1420, jitter info 1422, CRC 1424, priority info 1426 and dependence frame IDs 1428.

The source node ID 1402 is the ID of the node from which the packet has originated. The destination node ID 1404 is the ID of the ultimate sink for the data being generated. The destination node ID 1404 may include multiple destination IDs for multi-casting as explained in detail in conjunction with FIG. 13 above. The next Hop ID 1406 is included for multi-hop routing and contains the ID of the node, which is next in the path from the source node to destination node. Each of these fields may be 32-bit in width.

The path ID 1408 is the ID of the path that is to be used for routing data up to the destination node. The source node can fill this field so that intermediate nodes cannot change the path. Alternatively, the field is left unfilled to allow intermediate nodes to change paths to satisfy latency requirements. This field may be 8-bit wide. The fields 1402-1408 are required for routing packets in the network 100.

The next field, frame ID 1410, includes the frame number of the frame from which the packet was created. This field is required to identify all the packets of a particular frame, and it can be 16 bits wide. Field 1412 includes the total number of packets into which the original frame was divided. The packet No. 1414 field includes the packet number. This number is required at the destination to assemble the complete frame from a number of packets. As the packets can follow different paths and reach the destination out of order, this field is used by the destination node to reconstruct the original frame. The packet no. 1414 field can be 16 bits. The packet no. field is reset to 1 for the first packet of every new frame; thereby allowing a node to detect duplicate packets (the combination of frame ID, and packet ID generates a unique ID for each packet).

The frame Type 1416 has been provided so that the node can differentiate between compressed and uncompressed frames. For compressed frames, the field also indicates the type of compressed frame (MPEG frame, I-frame, P-Frame, and so on). This field can be 8 bits. The fields 1410-1416 are required for frame control.

The payload 1418 contains the actual data. The latency info 1420 contains the maximum latency requirement of the packet along with other latency related information. This field is updated by each intermediate node. The jitter info 1422 contains information about the acceptable latency jitter for the packet. This field is not updated at each node. Both these field can be 16 bits wide. The CRC 1424 field includes a 32-bit Cyclic Redundancy Checksum for the complete packet. This field is required for checking if the packet has been corrupted during transmission.

The priority info 1426 is an optional field, it can be added if some kind of priority needs to be added to packets in the network. The dependence frame IDs 1428 field is also an optional field. It can be added if any dependence exists between frames. This field, which is 32-bit in width, contains the frame IDs (up to 2) of the parent frame, on which the current frame is dependant. This can be used to drop packets when the packets of the parent frame are dropped. For example, for an MPEG compressed stream, the packets of a P-frame contain the frame ID of the I-frame or another P-frame on which it is dependant, in the Dependence Frame ID field. Priority Info and Dependence Frame ID can be used without each other independently or they can be used in conjunctively.

### Acknowledgment Packet

Turning now to FIG. 15, an acknowledgment packet 1500 sent by nodes in response to receiving a data packet 1400 in accordance with one embodiment of the present disclosure is described herewith. This packet 1500 includes source ID 1502, next hop ID 1504, frame ID 1506, packet number 1508, destination IDs with latency information for each 1510, frame ID and source ID pairs for dropped packets 1512, current queue length 1514, and CRC 1516. The fields 1502-1508 are directly copied from the data packet for which the acknowledgement is being sent. The source ID 1502, the frame ID 1506 and the packet no. 1508 are combined to find out which packet is being acknowledged. The next hop ID 1504 is the ID of the node, which is sending the acknowledgement. The field destination IDs with latency information for each 1510 includes a list of all neighbor nodes along with latency info for each node and it is provided to all neighbor nodes.

Apart from these, if the node has dropped some frames, it will send the list of frame ID-source ID pairs 1512 in the acknowledgement, so that its neighbors can also drop packets of these frames. Apart from this, the node also sends the current queue length 1514 information in the acknowledgment. This field is provided to give other nodes some indication of the level of congestion at the node. The CRC 1516 is Cyclic Redundancy Checksum for the complete acknowledgement packet 1500.

### Beacon Packet

Turning now to FIG. 16, a beacon packet 1600 sent by nodes in the network 100 is described herewith. The beacon packet 1600 includes the node ID 1602 of the node, which is sending the beacon. It also contains a list of the current neighbors of the node 1604. The beacon packet 1600 further includes destination node ID with latency info for each 1606 field. This field includes a list of all neighbor nodes along with latency info for each node 1606.

Apart from these, if the node has dropped some frames, it will send the list of frame ID-source ID pairs 1608 in the beacon, so that its neighbors can also drop packets of these frames. The current queue length 1610 and the traffic 1612 encountered in the last beacon are also sent in the beacon 1600. The CRC 1614 is Cyclic Redundancy Checksum for the complete beacon packet 1600.

### CONCLUSION

Although embodiments for implementing various methods and systems for improving the quality of real time data streaming have been described in language specific to structural features and/or methods, it is to be understood that the subject of the appended claims is not necessarily limited to the specific features or methods described. Rather, the specific features and methods are disclosed as exemplary implementations for providing one or more techniques to improve the quality of real time data streaming.

We claim:

1. A method for improving the quality of real time data streaming over a network comprising a plurality of nodes, including one or more source nodes, one or more destination nodes, and zero or more intermediate nodes, the source node transmits a real time data packet to the destination node, the method comprising:
obtaining maximum latency of one or more real time data packets of a data frame at the source node; and
routing the packets from the source node to the destination node through zero or more intermediate nodes such that the packets reach the destination node before the maximum latency is over, wherein each packet includes information about the maximum latency;
wherein, the maximum latency of a packet is updated by each intermediate node through which the packet is routed, wherein each intermediate node subtracts time spent by the packet at the intermediate node from the maximum latency value received along with the packet.

2. The method of claim 1 further comprising dropping a real time data packet at the source node or at the intermediate nodes when the time taken to reach the destination node exceeds the maximum latency of the real time data packet.

3. The method of claim 2, wherein the dropping further includes in response to dropping one or more packets of the data frame at a current node, dropping one or more remaining packets of the data frame in the current node and one or more neighboring nodes, wherein in response to dropping one or more packets of the data frame at the current node, the current node sends data frame drop information including the data frame ID and source node ID to neighboring nodes, in response to receiving the data frame drop information, the neighboring nodes drop zero or more packets based on received data frame ID and source ID, the current node is a node in one or more nodes through which the packet is routed to the destination node.

4. The method of claim 2, wherein the data frames are assigned a priority, wherein higher priority data frames are linked to lower priority data frames, such that the lower priority data frames are dependent on high priority data frames, the priority of the data frames is further assigned to the packets of the data frame.

5. The method of claim 4, wherein the dropping further includes in response to dropping one or more packets of the data frame at the current node, dropping one or more packets of lower priority data frames at the current node and one or more neighboring nodes, wherein in response to dropping the one or more packets of the data frame at the current node, the current node sends the data frame drop information including data frame ID and associated priority of the data frame dropped to neighboring nodes.

6. The method of claim 4, wherein at each node higher priority packets with lowest value of maximum latency available are transmitted first

7. The method of claim 1, wherein the obtaining maximum latency further comprises determining the maximum latency based on latency between the real time data packets and latency between the data frames.

8. The method of claim 1, wherein the obtaining maximum latency further comprises determining the maximum latency based on latency offered by one or more neighbor nodes of the source node.

9. The method of claim 1, wherein each node marks the time when the packet is received at and transmitted from the node and before sending the packet to neighboring node, each node uses the marked time to calculate the time spent by the packet in the node.

10. The method of claim 1 further comprising determining at each node latency characteristics of one or more neighboring nodes using beacons and packet acknowledgments received from the one or more neighboring nodes.

11. The method of claim 10, wherein the routing further comprises:
forwarding a real time data packet from a current node to a neighbor node based on:
a. the maximum latency of the packet;
b. time spent by the packet at the current node; and
c. latency characteristics of the one or more neighboring nodes;
the current node is a node in one or more nodes through which the packet is routed to the destination node.

12. The method of claim 1 further comprising determining at each node latency characteristics of paths to various destination nodes using beacons and packet acknowledgments received from one or more nodes in the paths.

13. The method of claim 12 wherein the routing further comprising:
selecting a path from source node to the destination node at the source node, for a packet of the data frame based on:
a. the maximum latency for the packet;
b. time spent by the packet at the source node; and
c. latency characteristics of paths to the destination node;
specifying the selected path in the packet; and
sending the packet based on the path specified in the packet.

14. The method of claim 1, wherein the routing further includes multi-casting by transmitting a packet to multiple destination nodes when one or more intermediate nodes are common for the multiple destinations.

15. The method of claim 1 further comprising sending beacons by each node in the network, the beacons include information regarding one or more of node ID of the node, neighboring nodes, number of packets dropped, data frame ID of packets dropped, types of packets dropped, priority of packets dropped, traffic information and queue length of the node.

16. A network node, comprising:
at least one transceiver for transmitting and receiving signals, wherein the signals include real-time data, beacons and acknowledgement signals;
a memory module for storing latency characteristics; and
a processing module configured to:
obtain maximum latency of one or more real time data packets of a data frame at a source node;
route the real time data packets to a destination node through zero or more intermediate nodes such that the one or more packets reach the destination node before maximum latency is over; and
update the maximum latency of the real time data packet by subtracting time spent by the packet at the node from the maximum latency value received along with the packet.

17. The node of claim 16 wherein the processing module is further configured to drop one or more packets when the time taken to reach the destination node exceeds the maximum latency of the one or more packets.

18. The node of claim 16, wherein the latency characteristics of the node comprises at least one of node ID, neighboring nodes, number of packets dropped, data frame IDs of packets dropped, types of packets dropped, priority of packets dropped, traffic information and queue length.

19. A network comprising:
a plurality of nodes transmitting real-time data packets, wherein the real-time data packets include information about maximum latency, the plurality of nodes is configured to:
obtain maximum latency of one or more packets of a data frame of the real time data at the source node;
route the one or more packets from the source node to a destination node in the plurality of nodes through zero or more intermediate nodes such that the one or more packets reach the destination node before the maximum latency is over; and
update the maximum latency of a packet at each intermediate node through which the packet is routed, wherein the each intermediate node subtracts time spent by the packet at the each intermediate node from the maximum latency value received along with the packet.

20. The network of claim 19 wherein the plurality of nodes are further configured to drop one or more packets at the source node or the intermediate nodes when the time taken to reach the destination node exceeds the maximum latency of the one or more packets.
